(19) United States
(12) Patent Application Publication
(10) Pub. No.: US 2002/0049643 A1
(43) Pub. Date: Apr. 25, 2002

(54) On-line ingredient exchange system and method

(76) Inventor: Diana L. Church, Fishers, IN (US)

Correspondence Address: Doreen J. Gridley, ICE MILLER, One American Square, Box 82001, Indianapolis, IN, 46282-0002, US

(21) Appl. No.: 09/965,262

(22) Filed: Sep. 27, 2001

Related U.S. Application Data
(63) Continuation-in-part of application No. 09/671,319, filed on Sep. 27, 2000.

(51) Int. Cl. G06F 17/60

(52) U.S. Cl. 705/26

(57) ABSTRACT

A method and system for an on-line ingredient exchange. The system includes a database which contains a name identifier and at least one certification for at least one raw material. The system also includes a data processor operably connected to the database, a terminal for entry of at least one name identifier or certification, and a communication link between the terminal and the processor. The method of exchange of ingredients using this system includes the steps of establishing communication between the terminal and the processor, entering at least one name identifier or certification of a raw material at the terminal, selecting with the processor the at least one raw material from the database that satisfies the data entered, and communicating the selected at least one raw material via the communication link to the terminal. The method and system of the present invention allows for the exchange of raw materials across SIC Codes and HTS indices. Also, the characteristics, certifications, and registrations of an ingredient are used as criteria to more accurately and efficiently match buyers and sellers of raw materials. In one embodiment of the invention, the system includes the electronic transfer of electronic records representing certifications, registrations, and characteristics associated with the raw materials, which can follow the transaction, thus providing users the ability to view the information required to complete the transaction. The system tracks such information through the entire supply chain of raw materials contained in an end product, regardless of whether the system was used for any exchange of such raw materials.

### RELATED PATENT APPLICATION

This patent application is a continuation-in-part of Ser. No. 09/671,319, entitled ON-LINE INGREDIENT EXCHANGE SYSTEM AND METHOD, filed on Sep. 27, 2000.

### FIELD OF THE INVENTION

The present invention relates to a method and system for the exchange of products and information related thereto.

### BACKGROUND OF THE INVENTION

Due to technological advances, commercial transactions between buyers and sellers have evolved from face-to-face transactions to more complex, automated transactions in a vast spectrum of industries. For example, in U.S. Pat. No. 5,715,402, buyers and sellers of spot metals are matched via an auction by e-mail or facsimile. In another example, the system of U.S. Pat. No. 5,950,178 uses a data processing system to match buyers and sellers transacting in precious stones.

Increasingly, buyers and sellers are utilizing various Internet technologies to complete commercial exchanges. It is well-established that Internet exchanges match buyers and sellers automatically, by selections made by the user, or by auctioning or reverse auctioning techniques. For example, the Internet exchange of www.esteel.com (Sep. 25, 2000) matches buyers and sellers transacting in the steel industry.

Several Internet exchanges exist in the ingredient industry. The term “ingredient industry” as used herein encompasses those businesses which manufacture, buy and/or sell raw materials (e.g., food acids, flavors, and vitamins) for the production of various goods for use by humans (generally, those raw materials which are regulated by the Food and Drug Administration of the United States Department of Health and Human Services (“FDA”). The ingredient industry is divided into subcategories, including but not limited to the food, beverage, pharmaceutical, cosmetic, and personal care ingredient industries. Each of these subcategories may be identified with different Standard Industrial Classifications (“SIC Codes”) or by the Harmonized Tariff Schedule of the United States (“HTS”).

SIC Codes and the descriptions of the items identified by a particular SIC Code are established by the Executive Office of the President in the Office of Management and Budget's Standard Industrial Classification Manual. SIC Codes provide an index with mutually exclusive topics that are used routinely in domestic commerce to classify products and services available in various industries. SIC Codes are periodically amended. The HTS implements the International Convention of the Harmonized Commodity Description and Coding System and provides an internationally agreed upon system for the classification of goods. The HTS contains an international index with mutually exclusive topics that has been used routinely in international trade to classify goods for the purpose of assessing and imposing import duties. The HTS is also periodically amended.

A shortcoming of the existing Internet ingredient exchanges, however, is that they do not allow for the exchange of ingredients across all subcategory lines from different SIC Codes and/or from different HTS indices. Products from one of the industry subcategories, such as the pharmaceutical subcategory, may be made with or as ingredients from another industry subcategory such as the food subcategory. Further, goods from one HTS index may be used with or as ingredients having a different HTS index. For example, www.globalfoodexchange.com (Sep. 25, 2000) only allows a buyer or seller to transact in food ingredients while www.ecfood.com (Sep. 25, 2000) only allows for an exchange of ingredients in the food and beverage subcategories. Therefore, an individual needing a food, cosmetic, and pharmaceutical ingredient must visit a plurality of Internet sites which is an inefficient process for buyers and sellers.

A further limitation of current Internet ingredient exchanges is that the only criterion used to match buyers and sellers is the general classification of the ingredient. For the purposes of this application, the term “classification” refers to the name identifier of an ingredient such as Calcium. The classification of an ingredient is a very broad criterion on which to match buyers and sellers because a single classification includes ingredients with different characteristics, certifications, and registrations. The characteristics, certifications, and registrations of an ingredient may vary widely within a single classification. Within the ingredient industry, the term “characteristic” means the distinctive qualities, traits, forms, or specifications of an ingredient and the term “certification” means a guarantee that the ingredient meets the standards or range limits set forth by the numerous organizations or agencies regulating the ingredient industry. The ingredient industry is very heavily regulated by these numerous organizations and agencies as ingredients may create important health and human safety risks. Generally, the certifications are written documents. A few of the organizations regulating the United States ingredient industry are the FDA and the Drug Enforcement Agency (“DEA”). A “registration” is a unique identifier given to an ingredient or company by an organization concerned with certain sectors of the ingredient industry. For example, the Chemical Abstract Service assigns a CAS Registry Number to chemical substances. Also, the DEA assigns a DEA registration number to authorized buyers and sellers of certain pharmaceutical ingredients such as codeine phosphate.

Although www.ecfood.com (Sep. 25, 2000) lists whether a certification is available for a particular food or beverage product, it does not utilize certifications as a criterion for matching buyers and sellers. Because current Internet ingredient exchanges match buyers and sellers based on the very broad classification criterion, after a transaction has occurred, the buyer and seller need to discuss whether the ingredient possesses the correct characteristics, certifications, and registrations. This process is inefficient and is very frustrating for the parties to the transaction.

To illustrate this shortcoming of the prior art, consider the following example. An Internet ingredient exchange matches a buyer and seller of the ingredient classified as Ingredient X. The buyer, however, desired an Ingredient X that possessed the characteristics of being a United States Pharmacopeia (“USP”) grade powder with a mesh-size of 20, while the seller's Ingredient X was a Food Chemical Codex (“FCC”) grade powder with a mesh-size of 60 (USP and FCC standards are legally recognized standards of identity, quality, strength, purity, packaging, and labeling for certain ingredients established by organizations regulating particular sectors of the ingredient industry). Further, the buyer needed Kosher and Passover certified Ingredient X while the seller's Ingredient X was neither Kosher nor Passover certified. The buyer and seller must again attempt to complete a transaction because the parties' previous attempt failed to meet their respective needs. Thus, it is desired to provide a marketplace for ingredients which utilizes characteristics, certifications, and registrations to further identify the ingredients beyond the name identifier.

A further shortcoming of the prior art is that the seller of an ingredient must manually put together all the paperwork respective of the characteristics, registrations, and certifications for an ingredient and somehow transfer it to the buyer, who is waiting for the arrival of this information. In many instances, due to the strict requirements of the organizations regulating the ingredient industry, before the buyer can further transact with respect to the ingredient purchased, such as by including the ingredient in a finished product or reselling the ingredient, the buyer must receive this information from the seller. In addition to needing information about ingredients in order to comply with the requirements of the various entities regulating the ingredient industry, those involved in the ingredient industry also need to have information about an ingredient available for product liability and quality control reasons. Certain information must be transferred to the buyer prior to shipment of the ingredient. Other information must travel with the shipment of the ingredient. It is even acceptable for some information to arrive after the buyer receives the shipment of an ingredient. Because the buyer often must await the arrival of certain information, there is lost time in the transaction process which again illustrates the inefficiency of the prior art in terms of both time and money.

An additional shortcoming of the prior art is that current on-line ingredient exchanges do not provide for the maintenance and transfer of information associated with the ingredients that are exchanged. Regulatory agencies, such as the FDA, often require that certain information about ingredients be maintained or submitted to the regulatory agencies by those involved in the ingredient business. If a buyer of ingredients uses several different ingredient exchanges to purchase ingredients (which is likely given that current on-line ingredient exchanges do not allow for exchanges across subcategories of ingredients), the buyer may only be able to retrieve limited information about an ingredient from the on-line exchange that was used for that particular transaction. Such limited information generally comprises the name identifier, price and quantity of the ingredient purchased. If a product comprises several ingredients, no composite information is available about all the ingredients included in the product. Also, no trail is available for the entire supply chain. Only information about the individual transactions may be obtained. For example, if a coloring agent is added to a powder, which is subsequently mixed with salts and seasonings for a baking mix, no composite information is available for all these ingredients. Further, the manufacturer of the baking mix may not have access to certifications and other documents about the coloring agent.

Another shortcoming of the prior art is that if the buyer or seller is required to transfer a signature to the other party for any reason, the transfer of the signature must be completed manually. Signatures are often required between buyers and sellers transacting in ingredients for reasons of identity, authority, or witness. For example, a purchase order submitted by a buyer may require a signature from someone within the company authorized to approve the purchase. Current Internet exchanges in the ingredient industry are costly with regard to time and money as the necessary signatures of the parties to an ingredient transaction must be transferred manually.

For the foregoing reasons, it is desired to provide a method and system that allows for the exchange of ingredients across all subcategories of the industry containing ingredients from different SIC Codes and/or different HTS indices at a single Internet site, thus eliminating the need to visit a plurality of Internet sites to purchase or sell ingredients. It is further desired to provide a method and system whereby the characteristics, certifications, and registrations of an ingredient are used as additional criteria to more accurately and precisely match buyers and sellers of a particular classification of ingredient. Furthermore, it is desired to provide a method and system that provides for the electronic transfer of the required documents relating to the characteristics, certifications, and registrations desired and/or required for an ingredient transaction, regardless of which ingredient exchange is utilized for the transaction, thereby streamlining the process for the buyer and seller. It is also desired to provide an ingredient exchange system which does not require the signature of either the buyer or seller on any paper to complete the transaction, but rather utilizes electronic signatures. Further, it is desired to provide a method and system in which the electronic transfer of required documents relating to the ingredients, as well as the associated electronic signatures, are trustworthy, reliable, and are generally equivalent to paper records and handwritten signatures executed on paper. Finally, it is desired to provide a system and method to track all relevant documents through the entire supply chain of ingredients contained in an end product.

### SUMMARY OF THE INVENTION

The present invention comprises an online ingredient exchange method and system. The present invention further comprises a method and system for the electronic maintenance and transfer of certain information about ingredients, regardless of whether the present invention is utilized for an ingredient exchange. In one embodiment, the system utilizes the Internet and is primarily intended for business to business ingredient exchanges; however, it is also conceptually applicable to other technologies and to exchanges involving individual consumers. Unlike other Internet exchanges for ingredients, the present invention allows a user to participate in exchanges across all subcategories of the ingredient industry (e.g., mutually exclusive SIC Codes and/or HTS indices) at a single location on the Internet.

The system includes a database residing on or associated with a processor, such as a personal computer or a server. The database includes information about at least one raw material including, but not limited to ingredients. That information includes, but is not limited to, one or more of the following: a name identifier, a characteristic, a certification, and a registration. Users of the system can commnunicate with this database by communication means well known in the art, such as by connection of a terminal (computer, hand-held device, personal data assistant, telephone, and the like) to the Internet, where the processor is also connected to the Internet.

By use of this configuration, at a single Internet site, a user enters information about the particular ingredient(s) in which he or she wishes to transact. Unlike the prior art, the present invention uses additional criteria besides simply the name identifier of the ingredient to match buyers and sellers of ingredients. As previously stated, the additional information that a user may enter includes, but is not limited to certifications, registrations, and characteristics associated with the ingredient. As to the method of the ingredient exchange of the present invention, the information entered by the user is communicated to a central processing unit (“CPU”) which processes the information and the information is then stored in a database. The CPU matches buyers and sellers of ingredients based on the name identifier and any other additional information entered by the user about the ingredients. The match is then communicated to the respective parties. Of course, the criterion entered is applicable to both buyers and sellers of ingredients.

Because the present invention utilizes much more specific criteria for matching buyers and sellers of ingredients, it more accurately and precisely matches the needs of the parties and eliminates the need for the parties to a transaction to discuss whether the ingredient to be exchanged actually possesses the necessary characteristics, certifications, and registrations. Thus, the present invention saves both time and money for the parties involved in the transaction.

Further, because the ingredient industry is heavily regulated by numerous agencies and organizations, the buyer and/or the regulatory agencies may require proof that the ingredient possesses certain characteristics, registrations, and certifications before the ingredient is used in a product or resold by the buyer. Buyers of ingredients may also want this information for purposes of quality control and product liability. The present invention allows for the creation, modification, maintenance, archival, retrieval, and distribution of an electronic certificate or record representing the characteristics, registrations, and certifications associated with an ingredient. This electronic record may also represent other information about the ingredient. As used herein, the terms “electronic certificate” and “electronic record” are used interchangeably. According to the FDA, at 27 C.F.R. Part 11, an electronic record is any combination of text, graphics, data, audio, pictorial, or other information representation in digital form that is created, modified, maintained, archived, retrieved, or distributed by the system of the present invention. These types of electronic records are within the scope of the meaning of the terms “electronic record” or “electronic certificate” in the present application. Therefore, a seller of an ingredient does not have to manually put together the necessary paperwork for an ingredient and somehow transfer it to the buyer, who then may be required to transfer the information to the organizations regulating the ingredient industry. The present invention further allows for the creation, modification, maintenance, archival, retrieval, and distribution of information associated with an ingredient, such as characteristics, regardless of whether the ingredient is exchanged through the method and system of the present invention. Further, such records can be maintained and made available for all ingredients and subingredients in a product to all those in the supply chain of ingredients contributing to an end product.

In addition to paper records, increasingly regulatory agencies, such as the FDA, are allowing the use of electronic records to comply with their requirements. If electronic records may be filed with the organizations regulating the ingredient industry, these organizations may also have extensive rules and regulations for the systems that create, modify, maintain, and transmit electronic records and for the electronic record itself in order to ensure the authenticity, integrity, and, if applicable, the appropriate confidentiality of the electronic records. For example, electronic records required to be maintained by the FDA or submitted to the FDA must comply with the requirements of 21 C.F.R. Part 11. Therefore, the system of the present invention and the electronic records created thereby comply with 21 C.F.R. Part 11, as well as all other such applicable regulations.

In addition, the present invention allows for buyers to request samples of the ingredient to be exchanged from the seller as further proof that the ingredient possesses the necessary characteristics. The present invention also provides for the electronic transfer of necessary signatures required by the parties in order to consummate the exchange. Thus, the parties to an ingredient exchange do not have to manually transfer required signatures.

As defined by the FDA in 21 C.F.R. Part 11, an electronic signature is a computer data compilation of any symbol or series of symbols executed, adopted, or authorized by an individual to be the legally binding equivalent of the individual's handwritten signature. Electronic signatures include, but are not limited to digital signatures. In 21 C.F.R. Part 11, the FDA further defines a digital signature as an electronic signature based upon cryptographic methods of originator authentication, computed by using a set of rules and a set of parameters such that the identity of the signer and the integrity of the data can be verified. The term “electronic signatures,” which includes digital signatures, as used in the present applicable, fall within the FDA's definition of the terms “electronic signatures” and “digital signatures.” If electronic records are submitted to the regulatory agencies, these electronic records may be signed via an electronic signature.

Similar to the requirements for electronic records, the organizations regulating the ingredient industry also may have requirements for the electronic signatures. For example, the FDA's regulations for electronic signatures require, among other things, that electronic signatures be linked to their respective electronic records to ensure that the electronic signatures cannot be manipulated to falsify the electronic record. The electronic signatures of the present invention comply with the requirements of the FDA, as well as the requirements of the other organizations regulating the ingredient industry for electronic signatures (if they are permitted as a substitute for handwritten signatures). These aspects of the present invention save the parties to an ingredient exchange both time and money. These and other features, aspects, and advantages of the present invention will become better understood with reference to the following description.

### BRIEF DESCRIPTION OF THE DRAWINGS

FIG. 1 shows a block diagram of the components of current ingredient exchange systems;

FIG. 2 is a flow diagram showing an overview of an on-line ingredient exchange method according to the present invention;

FIG. 3 shows one embodiment of an introductory page of the present invention;

FIG. 4 shows one embodiment of a subcategory page of the present invention;

FIG. 5 shows an exemplary ingredient offer to sell page of one embodiment of the present invention;

FIG. 6 shows an exemplary page depicting a summary of the submission of the ingredient offer to sell page according to one embodiment of the present invention;

FIG. 7 shows an exemplary ingredient inquiry to buy page of one embodiment of the present invention; and

FIG. 8 shows an exemplary page depicting a summary of the submission of the ingredient inquiry to buy page according to one embodiment the present invention.

### DESCRIPTION OF THE INVENTION

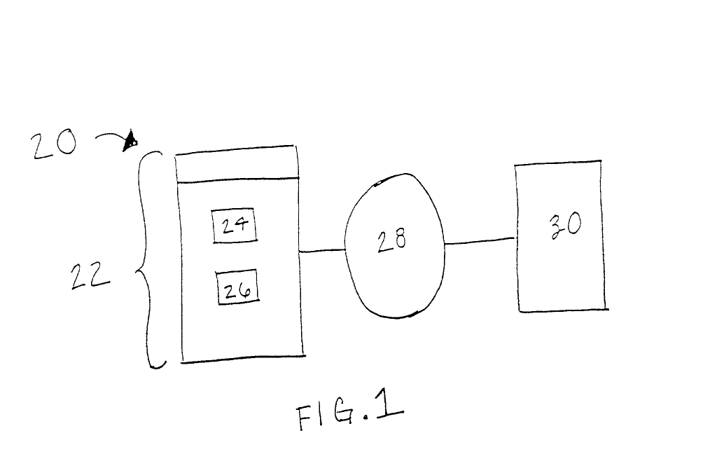

Referring now to FIG. 1, there is shown one embodiment of the components of the on-line ingredient exchange system according to the present invention. System 20 comprises host server 22, computer network 28, and remote device 30 for data entry. Remote device 30 may comprise a computer terminal, personal digital assistant device, another server, telephone, and the like. Besides remote device 30, data may also be transferred automatically to system 20 via an interface between other ingredient exchange systems (not shown) and system 20. Other embodiments of the present invention may comprise a plurality of remote devices, but this is not required.

In the embodiment shown in FIG. 1, host server 22 comprises CPU 24 and data storage means having a database 26 thereon. CPU 24 may comprise one or more processors, as is well known in the art, and host server 22 may be housed in a single computer or server, or across multiple computers or servers, as is well known in the art. Database 26 is the mechanism of system 20 in which data is retrievably stored. In the embodiment shown in FIG. 1, database 26 resides on host server 22. However, database 26 may be remote from CPU 24, or reside on a second server or computing device remote from host server 22, provided the remote second server or computing device is capable of bi-directional communication with host server 22, as is well known in the art. It is required that the data storage means having database 26 thereon be operably connected to CPU 24.

Database 26 may comprise any type of database. In one embodiment of the present invention, database 26 comprises a relational database which retrievably stores data associated with ingredients in many subcategories of the ingredient industry, including but not limited to the food, beverage, pharmaceutical, cosmetic, botanical and personal care subcategories of the ingredient industry. Each of these subcategories may be identified with mutually exclusive SIC Codes or by the HTS indices. In another embodiment of the present invention, database 26 may retrievably store data associated with a wide variety of other products and/or services.

Database 26 contains information about at least one raw material. The raw material(s) stored on database 26 may include ingredients as previously described. Associated with each of the raw material(s) stored on database 26 is a name identifier. A name identifier is the general term for a classification of the type of raw material. This name identifier is generally the common name for the raw material. In the food ingredient industry, representative name identifiers include, but are not limited to soy protein isolate, cocoa powder, lactic acid, dextrose, and methylcellulose gum. In the pharmaceutical ingredient industry name identifiers include, but are not limited to glucocorticoid, lutein, budesonide, and oseltamivir phosphate.

Remote device 30 communicates with host server 22 via computer network 28. The communication between remote device 30 and host server 22 must be bidirectional. In one embodiment of the present invention, other on-line ingredient exchanges (not shown) may interface and communicate with host server 22 bi-directionally. Computer network 28 may comprise the Internet, but this is not required. Further, when more than one remote device 30 is operably connected to host server 22, the communication link may comprise one or more networks, such as the Internet, cellular, or other remote communication means well known in the art, and any combination thereof.

In operation of system 20, remote device 30 is used to enter data relating to ingredients in which a party desires to transact or about which a party desires to enter and/or transfer information. Briefly, the data entered by users is communicated via computer network 28 to host server 22 and retrievably stored in database 26 and/or retrieved from database 26. Data regarding an ingredient may also be entered automatically from other on-line ingredient exchanges. CPU 24 processes the data and matches buyers and sellers based on the data each entered using remote device 30. It will be appreciated by those of skill in the art that buyers and sellers can be matched automatically, by the data entered by the buyers and sellers, or by auctioning or reverse auctioning techniques, as is well known in the art. If a user desires only to enter and transfer data about an ingredient, CPU 24 may also process the data entered and create and transfer an electronic record representing various information about an ingredient, even if system 20 is not utilized for the exchange of the ingredient.

When buyers and sellers are matched automatically, an ingredient profile is generated by the user entering information about an ingredient. The information may include, but is not limited to the name identifier, characteristics, certifications, and registrations associated with the ingredient. This profile is stored on database 26 or other storage device (not shown) and may be compared to other profiles existing in database 26 based on parameters specified by the user. This profile is considered a match to other profiles when information regarding the name identifier, characteristics, certifications and registrations are identical or equal based on one or more of the parameters of the profile. Once a match has occurred as determined by system 20, users are identified and the information is transferred to them.

The matching of buyers and sellers via an auction technique involves a process wherein buyers and sellers converge and sellers offer ingredients for sale. The seller enters information about the ingredient to be sold which may include, but is not limited to the name identifier, characteristics, certifications, and registrations associated with the ingredient. Buyers submit bids for the ingredient and then the ingredient is sold to the highest bidder. Sellers specify the parameters of the auction, including but not limited to the location of the auction, the time and date at which the offer for sale will expire, and the minimum price for ingredient bids. Sellers may accept or reject any bid. The auction technique for matching buyers and sellers of ingredients may include commodity trading or future contracts. These trading activities focus on the buying and selling of ingredients based on industry-accepted factors (e.g., crop status) to be delivered immediately or at a future date for a price determined at the time of the auction. Auctioning generally results in the highest price for the seller, as buyers bid in an upward pricing spiral until the seller accepts a bid.

When buyers and sellers are matched by a reverse auction technique, buyers and sellers converge and buyers enter information about the ingredient that the buyers wish to purchase. The information may include but is not limited to the classification, characteristics, certifications, and registrations associated with the ingredient the buyer desires to purchase. Buyers specify the parameters of the reverse auction, including but not limited to the location of the reverse auction, the time and date at which the bid will expire, and a maximum price the buyer will pay for the specified ingredient. Buyers may accept or reject any bid. Reverse auctioning generally yields the lowest price for the buyer, as sellers bid in a downward pricing spiral until the buyer accepts a bid.

Returning now to FIG. 1, after CPU 24 matches a buyer and a seller by any one of the techniques described above, computer network 28 communicates the match between the buyer and seller to remote device 30 thereby notifying the parties of the match. Orders may then be transacted over system 20 by means well known in the art.

It will be appreciated by those of skill in the art that the “match between the buyer and seller” referred to herein relates to a match between the data entered by the user and information about one or more raw materials residing on database 26. The system also contains information about the users of the system to identify the user, as is well known in the art. A match of the entered data regarding one or more raw materials can therefore be related to the user as either a buyer or a seller.

To operate the system according to the present invention, a user (including, but not limited to a buyer or seller of an ingredient) must enter into bi-directional communication with host server 22 using remote device 30. In one embodiment of the present invention, the user enters into bi-directional communication from remote device 30 with host server 22 via a specific uniform resource locator (“URL”) on the Internet. In this embodiment, the remote device includes a browser and after entering the URL on the address line of the browser, an introductory page is displayed on remote device 30.

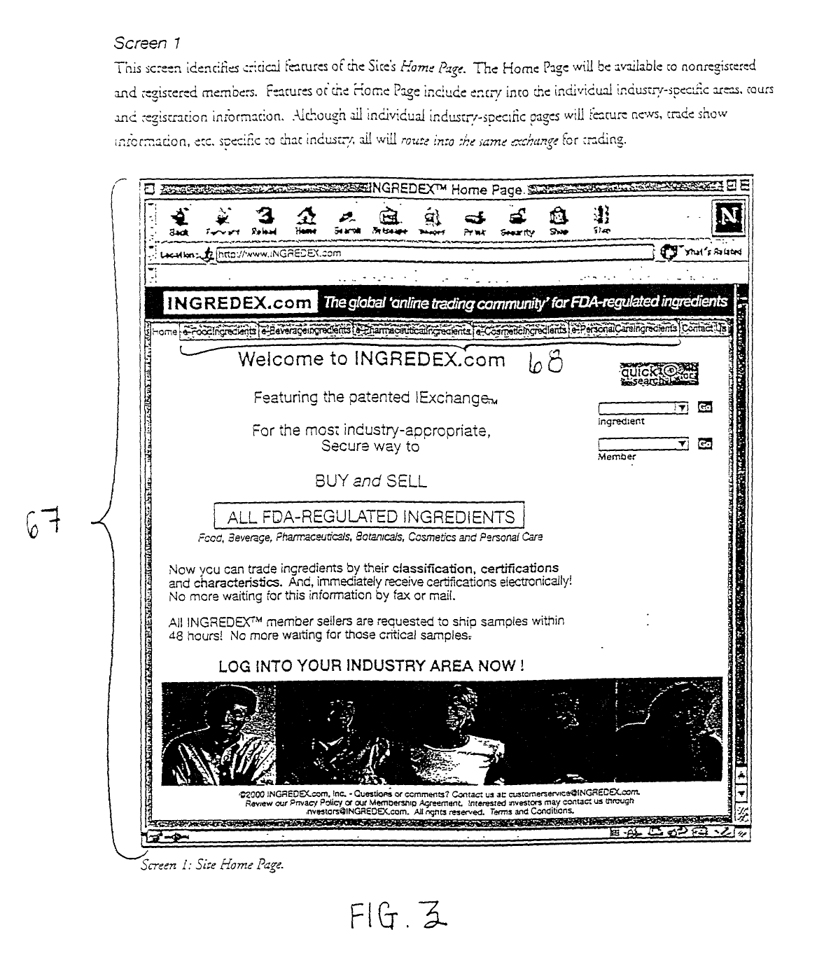

An exemplary introductory page 67 is shown in FIG. 3. The introductory page 67 is available to users who have established a passcode as described below as well as users who have not established a passcode, i.e., the introductory page is available to the public. The user may navigate the introductory page 67 and other pages of the present invention by using a mouse or other user interface device connected to remote device 30 as is well known in the art.

At introductory page 67, the user may choose to view a subcategory page for a particular subcategory of the ingredient industry by choosing from a subcategory menu 68. If the user chooses a particular subcategory, a subcategory page is shown on remote device 30.

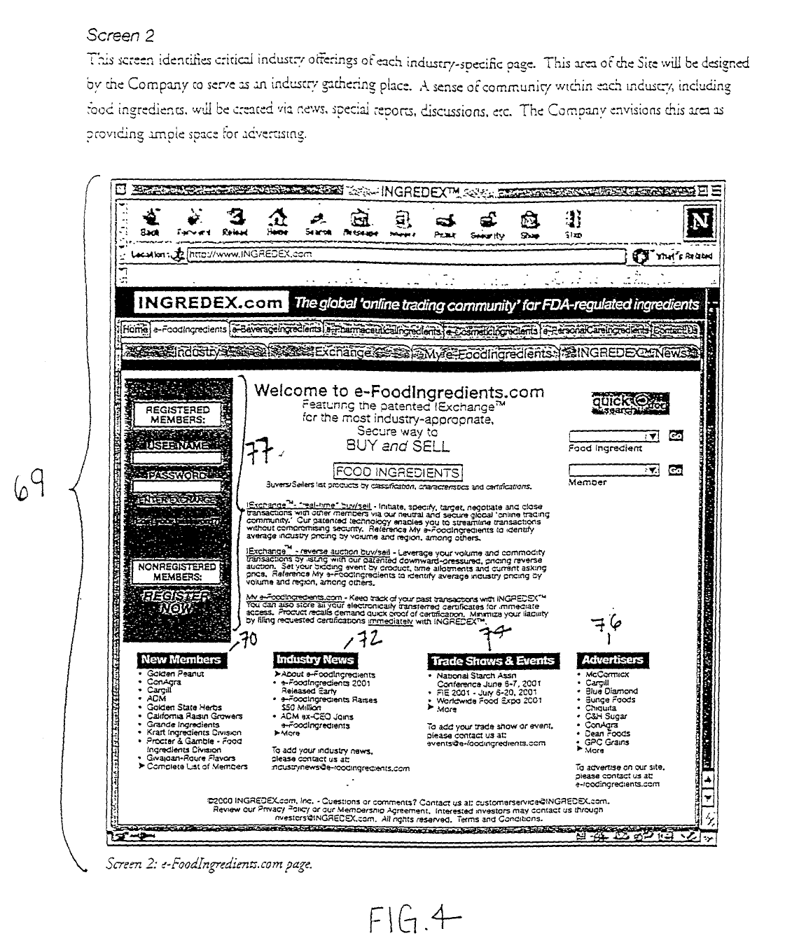

An exemplary subcategory page 69 for the food ingredients subcategory is shown in FIG. 4. The information about food ingredients includes, but is not limited to information about new members 70, news about food ingredients 72, information about trade shows and events for food ingredients 74, and advertisers of food ingredients 76. If the user chooses a different subcategory from subcategory menu 68 as shown in FIG. 3, similar information is available for the chosen subcategory.

As also shown in FIG. 4, in section 77, the user may enter a valid passcode to access system 20 or establish a valid passcode, as discussed below. The passcode is required to obtain full use of the system, including but not limited to participating in any transaction over exchange system 20.

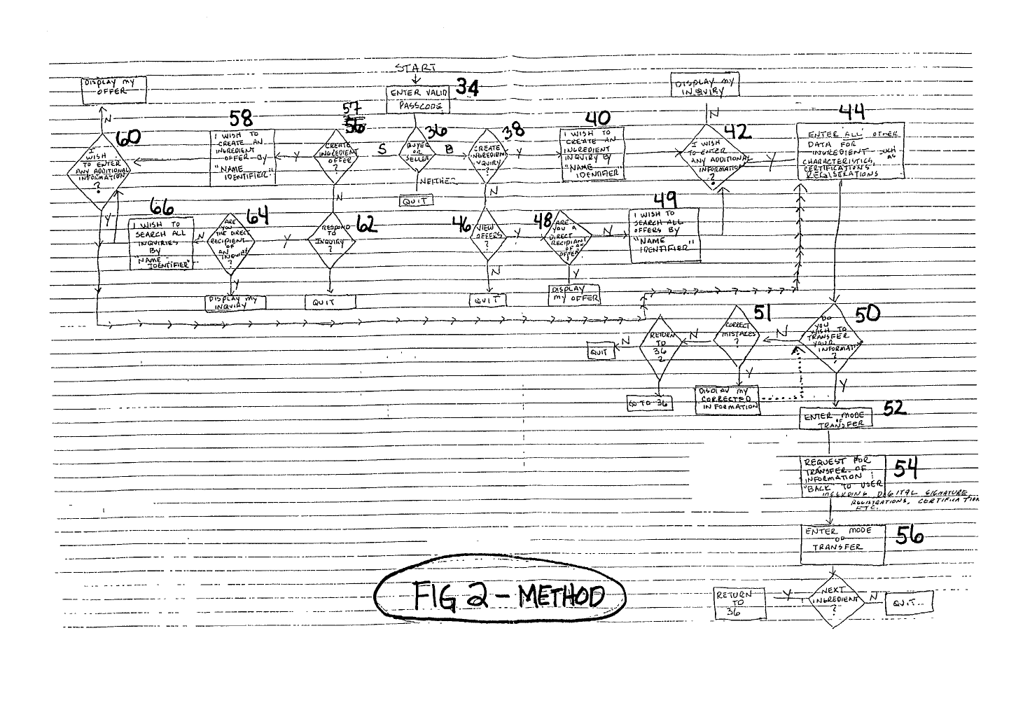

FIG. 2 shows a flow diagram of the method according to the present invention. A user will apply for a valid passcode and a passcode will be assigned to users of the system meeting certain criteria by means well known in the art. At step 34, the user enters his or her passcode. The passcode may be entered by the user at step 34 in a variety of ways, including but not limited to key entry, a verbal command, tone signals, or an electronic signature entered at remote device 30. At step 34, system 20 will prompt the user for his or her passcode. The user will be allowed several attempts to correctly enter his or her valid passcode; however, if the user repeatedly enters an invalid passcode, he or she will be instructed by the system to apply for a valid passcode. Such acceptance of a valid passcode is achieved by means well known in the art.

At step 36, the user must specify whether he or she is a buyer or seller, or whether he or she is using system 20 solely to enter and/or transfer information relating to an ingredient that was not exchanged via system 20. It will be appreciated by those of skill in the art that the system may recognize a user as a certain type of a user (e.g., a buyer or seller) based on information it retains about the user in association with the valid passcode. In such case, the user need not specifically identify itself as a buyer or seller, but, rather, this step 36 is automatically determined by the system. However, it will also be appreciated that a particular user may be both a buyer and seller of raw materials, as well as a user of system 20 solely for the entering and/or transferring of information about a raw material or ingredient. Thus, it may be desirable to require the user to identify purpose for which he or she is using system 20 for the following transaction.

If a user indicates in step 36 that he/she is a seller, at step 57 the seller is asked whether the seller wishes to create an offer to sell an ingredient. If the seller desires to create an offer, the seller is presented with an offer page and enters the name identifier associated with the ingredient in the offer page as indicated at step 58. For example, if the seller desires to create an offer for an anti-caking agent, he or she may enter the name identifier “anti-caking agent” at step 58.

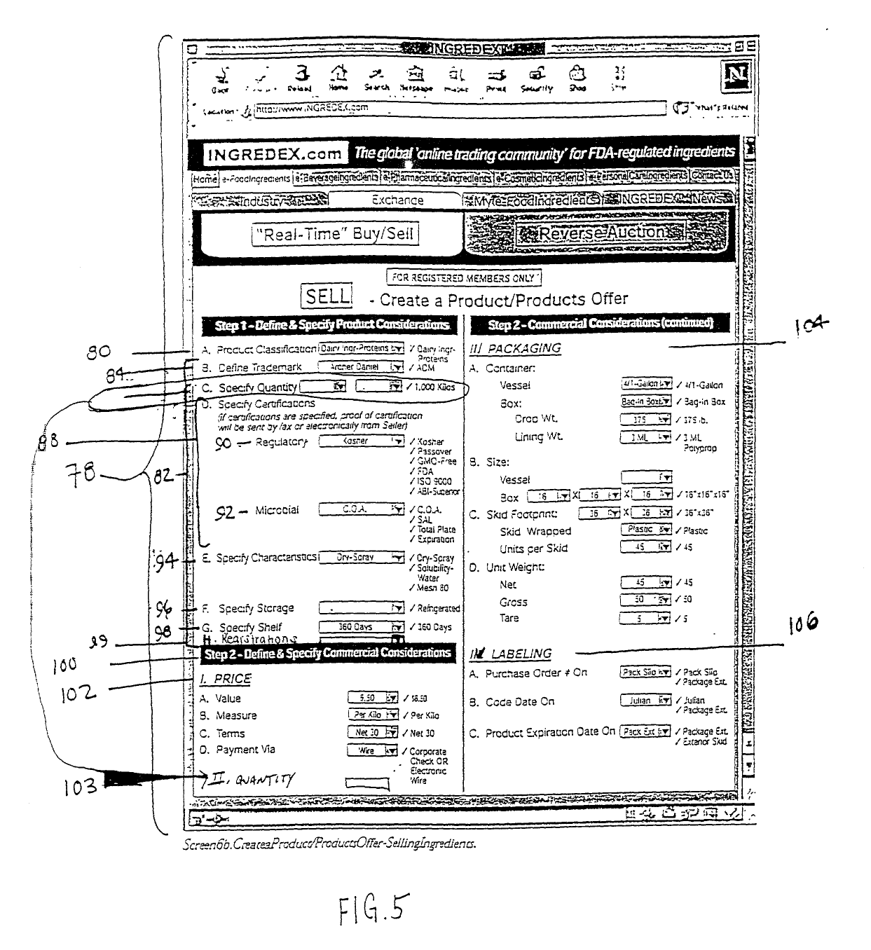

FIG. 5 shows an exemplary offer to sell page 78. In this embodiment, the seller enters the name identifier in section 80. At step 60 of FIG. 2, the seller is given the option of entering additional information about the ingredient at step 44. As shown in FIG. 5, the additional information 82 may include, but is not limited to trademarks associated with the ingredient 84; certifications associated with the ingredient 88 including but not limited to regulatory 90 and microbial 92 certifications; characteristics of the ingredient 94; the type of storage for the ingredient 96; the shelf life of the ingredient 98, and registrations 99 associated with the ingredient. Therefore, it is an advantage of the present invention to more efficiently match buyers and sellers of ingredients by utilizing additional information about an ingredient besides simply the name identifier of the ingredient.

After entering the name identifier and additional information about the ingredient, the seller may also decide to enter commercial considerations associated with the transaction at step 44. As shown in FIG. 5, the commercial considerations 100 include, but are not limited to price 102; the quantity of the ingredient desired 103; packaging 104, and labeling 106. Following step 44, the seller enters whether or not to proceed with the transaction by communicating the data entered to host server 22 at step 50. In one embodiment of the present invention, the seller may indicate the offer to sell an ingredient should only be transferred to certain buyers specified by the seller. Step 50 and the following steps are discussed hereinafter.

Returning to step 57, if the seller does not wish to create an offer to sell an ingredient, at step 62 the seller specifies whether he/she wishes to respond to an ingredient inquiry created by a buyer at steps 38, 40, 42, and 44, as discussed below. If the seller does not respond to an ingredient inquiry created by a buyer, the seller exits the system.

Buyers may enter ingredient inquiries targeting particular sellers, as described below. If the seller desires to respond to an ingredient inquiry directed specifically to the seller, the seller does so at step 64.

If the seller does not wish to respond to the buyers' targeted ingredient inquiries, the seller may choose to search the ingredient inquiries retrievably stored in database 26 by entering the name identifier associated with the ingredient at step 66. For example, the seller may search all ingredient inquiries created by buyers for anti-caking agents by entering “anti-caking agents” at step 66. At step 60, the seller may also enter additional information and commercial considerations associated with the ingredient to narrow the seller's search of ingredient inquiries at step 44, as described above. Thereafter, the seller may communicate the information entered to the host server 24 in steps 50 and 52 as discussed below.

As illustrated above, it is an advantage of the present invention for sellers to be able to search database 26 and create ingredient offers utilizing additional information associated with an ingredient in addition to using the standard name identifier of the ingredient.

At step 50, the information entered by a seller creating an offer to sell an ingredient or searching ingredient inquiries created by buyers is displayed. Errors in the information may be corrected by the seller at step 51. After the seller corrects the information at step 51, the seller returns to step 50. At step 50, the seller decides whether to communicate the information entered by the seller to host server 22 via computer network 28. If the seller does not desire to communicate the information to host server 22, the seller will be provided with the choice of exiting system 20 or returning to step 36. At step 36, the user must indicate whether he/she will be a buyer or seller for the next ingredient in which he or she desires to transact, or if the user will be entering and/or transferring information about an ingredient that is not being exchanged via system 20. If the user exits the system, the user will return to step 34 and must re-enter his or her valid passcode.

If the seller elects to transfer information to host server 22 at step 50, at step 52, the seller enters the mode of transfer of any information to be transferred to the seller related to the exchange of the ingredient. For example, the seller will be notified if a buyer responds to the seller's offer to sell an ingredient. The mode of transfer to remote device 30 of the information may include, but is not limited to transfer modes involving voice recognition, facsimile, video data, and tone signals as is well known in the art.

After the seller enters the mode of transfer at step 52, the seller may request the transfer from the buyer of any information associated with the exchange of the ingredient, including but not limited to the buyer's electronic signature or certificates or documentation representing the characteristics, certifications, and registrations of the ingredient at step 54. For example, the seller may require an authorized representative of the buyer to sign the seller's purchase order before the seller will transport the ingredient to the buyer.

After the seller enters the request for transfer of information at step 54, the seller enters the mode of transfer of any information regarding the ingredient transaction from the buyer at step 56. The transfer may occur electronically or through conventional means of transfer including, but not limited to the United Parcel Service. The mode of electronic transfer to remote device 30 of the information from the buyer to the seller may include, but is not limited to transfer modes involving voice recognition, facsimile, video data, and tone signals as is well known in the art.

In one embodiment of the present invention, after the seller finishes entering information about the ingredient he or she wishes to sell at step 44, the seller's offer is displayed in the form of a seller's summary page shown on remote device 30.

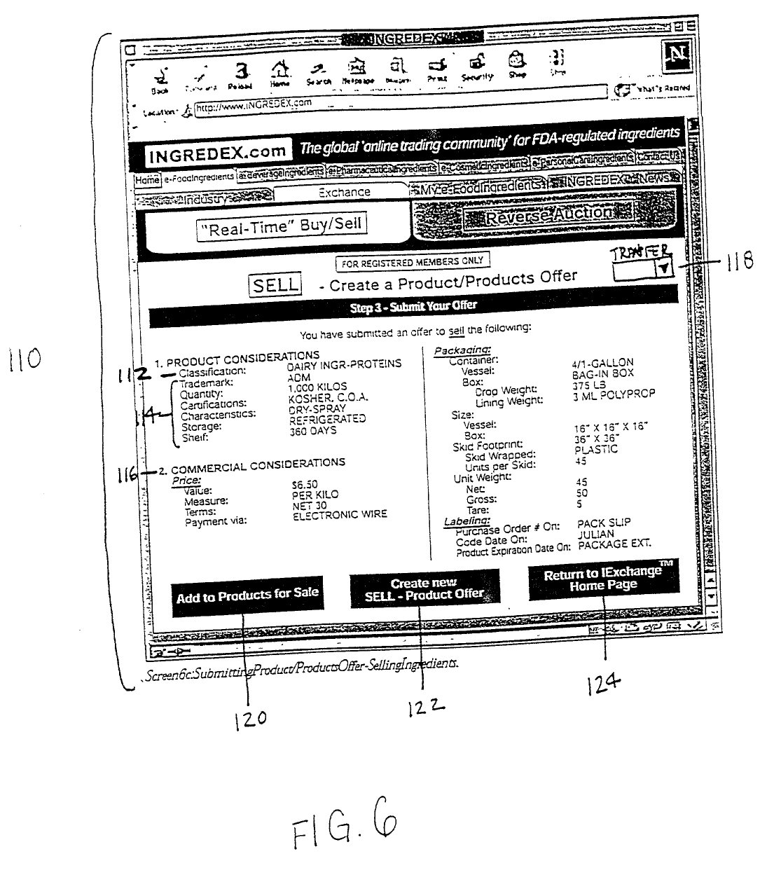

An exemplary seller's summary page 110 is shown in FIG. 6. The seller's summary page 110 includes all the information entered by the seller about a particular ingredient. The information shown on seller's summary page 110 includes the name identifier of the ingredient 112, the additional information about the ingredient 114, and the commercial considerations 116 associated with the ingredient entered by the seller. At option 118, the seller may request the transfer from the buyer to the seller of any information that may be required from the buyer in order to complete a transaction between the two parties. This information may include, but is not limited to the electronic signature of the buyer or documentation relating to the registrations of the buyer. At option 120, the seller can choose to transfer the information entered by the seller to host server 22 at step 50 and 52. At option 122, the seller can create another ingredient offer at steps 57, 58, 60, and 44 or delete all or part of the information contained in the ingredient offer in order to correct mistakes in the information at step 51. At option 124, the seller may also return to the introductory page 67 as discussed above with reference to FIG. 3.

Returning to step 36, if the user specifies that he or she is a buyer, at step 38 the buyer will indicate whether he or she desires to create an inquiry regarding an ingredient. If the buyer desires to create an ingredient inquiry, the buyer enters a name identifier associated with the ingredient about which the buyer is inquiring at step 40. For example, if the buyer is interested in an anti-caking agent, he or she may enter the name identifier “anti-caking agent” at step 40.

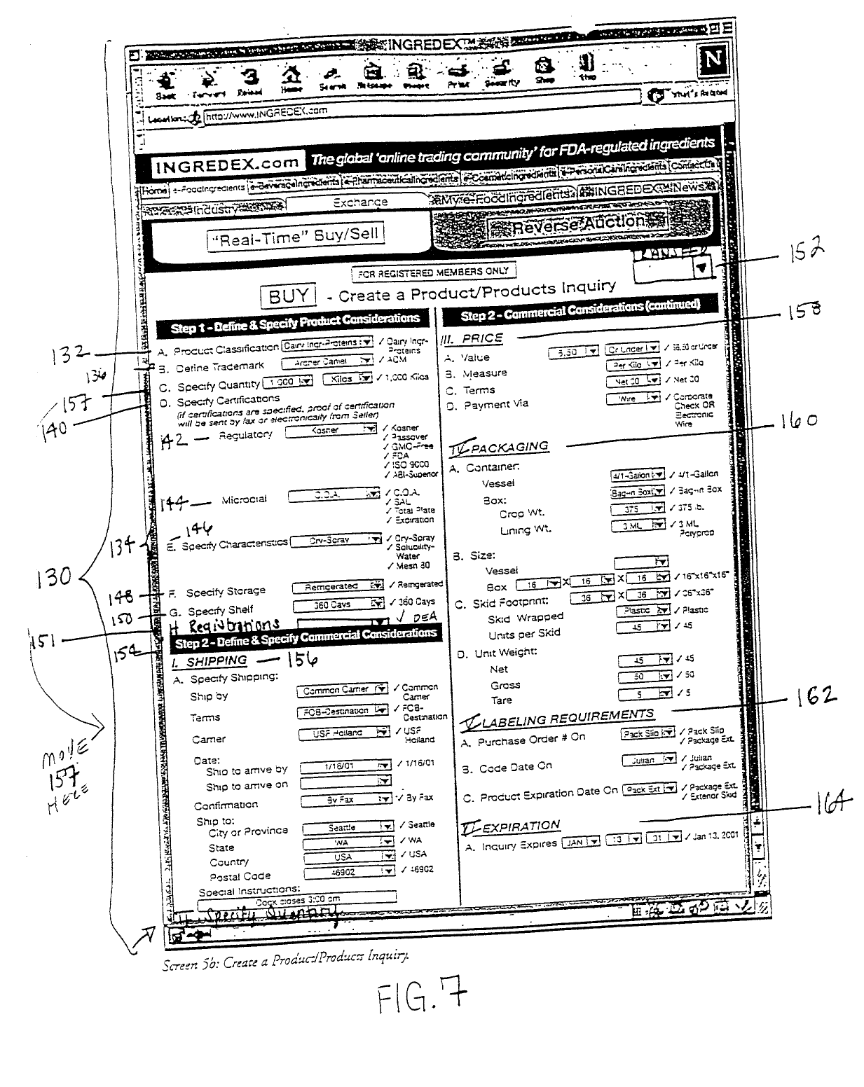

FIG. 7 shows an exemplary ingredient inquiry to buy page 130 associated with step 40. In this embodiment, the buyer enters the name identifier in section 132. At step 42 (see FIG. 2), the buyer is given the option of entering additional information about the ingredient for which the buyer is searching at step 44. As shown in FIG. 7, the additional information 134 a buyer may enter includes, but is not limited to trademarks associated with the ingredient 136; certifications associated with the ingredient 140, including but not limited to regulatory 142 and microbial 144 certifications; characteristics of the ingredient 146; the type of storage for the ingredient 148; the shelf life of the ingredient 150, and registrations 151 associated with the ingredients. At 152, the buyer may request the transfer of documentation from the seller to buyer as discussed below. Therefore, as previously stated, it is an advantage of the present invention to more efficiently match buyers and sellers of ingredients by utilizing additional information about an ingredient besides simply the name identifier of the ingredient.

Returning to FIG. 2, after entering the name identifier and additional information about the ingredient, the buyer then enters other commercial considerations associated with the ingredient, at step 44. As shown in FIG. 7, the commercial considerations 154 include, but are not limited to shipping 156, the quantity of the ingredient desired 157, price 158, packaging 160, labeling 162, and the expiration date of the ingredient inquiry 164.

Following step 44, the buyer decides whether or not to proceed with the transaction by communicating the data entered to host server 22 at step 50 as described above. In one embodiment of the present invention, the buyer may indicate that the ingredient inquiry is only transferred to certain sellers as specified by the buyer.

Returning to step 38, if the buyer does not desire to create an ingredient inquiry, the buyer may choose to view ingredient offers posted by sellers (as described above) at step 46. The buyer exits the system if he or she decides not to view offers posted by sellers as described below. If, however, the buyer chooses to view offers posted by sellers, the buyer may respond directly to sellers' offers directed specifically to him or her at step 48.

If the buyer does not wish to respond to offers directed specifically to the seller, the buyer may choose to search the ingredient offers retrievably stored in database 26 by entering the name identifier associated with an ingredient at step 49. After entering the name identifier, at step 42 the buyer is given the option of entering additional information and commercial considerations associated with the ingredient for which the buyer is searching at step 44, as described above in order to narrow the buyer's search of the ingredient offers.

As illustrated above, it is an advantage of the present invention for buyers to search database 26 for sellers' ingredient offers and create ingredient inquiries utilizing additional information about the ingredient the buyer desires to purchase besides simply the name identifier.

At step 50, the information entered by a buyer creating an ingredient inquiry or searching offers to sell ingredients by sellers is displayed. Thereafter, the buyer may communicate the information entered to host server 22 in steps 50 and 51, and specify the mode of transfer any information to be transferred to the buyer related to the exchange of the ingredient at step 52 as discussed above. If the buyer does not desire to communicate the information to host server 22, the buyer will be provided with the choice of exiting system 20 or returning to step 36. At step 36, the user must indicate whether he/she will be a buyer or seller for the next ingredient in which he or she desires to transact, or if the user will enter and/or transfer information about an ingredient that will not be exchanged via system 20. If the user exits the system, the user will return to step 34 and must reenter his or her valid passcode.

After the buyer enters the mode of transfer at step 52, the buyer may request the transfer from the seller of any information relating to the exchange of the ingredient including, but not limited to the seller's electronic signature or certificates or documentation representing the characteristics, certifications, and registrations of the ingredient at step 54. The buyer may also request a sample of the ingredient to be purchased from the seller in order to verify that the ingredient satisfies the requirements of the buyer. After the buyer enters the request for transfer at step 54, the buyer enters the mode of transfer at step 56 as described above.

In one embodiment of the present invention, the information associated with the ingredient is retrievably stored in database 26. After the buyer requests the electronic transfer of the information at steps 54 and 56, host server 22 retrieves the documentation from database 26 and generates an electronic certificate or record representing the requested characteristics, certifications, registrations, or other information associated with the ingredient by means well known in the art. Thereafter, the electronic certificate or record is transferred to the buyer. The buyer may also request that the electronic record be submitted to regulatory agencies such as the FDA.

For example, in order for a buyer of lactic acid to incorporate the lactic acid into an end product, the buyer may be required by an organization or agency regulating the ingredient industry to have and/or to submit to such organizations a Certificate of Analysis for the lactic acid. At step 54, the buyer requests that the seller electronically transfer the Certificate of Analysis for the lactic acid to the buyer, and that the seller authenticate the Certificate of Analysis with an electronic signature. An electronic record representing the Certificate of Analysis is generated and transferred to the buyer. At step 54, the buyer may also request that the electronic record representing information associated with the ingredient be transferred electronically to the organizations regulating the ingredient industry in order to comply with their respective requirements.

As stated previously, organizations regulating the ingredient industry may have requirements for electronic records and signatures, as well as for a system which creates, modifies, maintains, or transmits such electronic records. Such requirements may ensure the authenticity, integrity, and when appropriate, the confidentiality of the electronic records, for example. Therefore, system 20 and the electronic records it creates, modifies, maintains, archives, retrieves, or distributes comply with any such requirements including, but not limited to the requirements of the FDA as set forth in 21 C.F.R. Part 11.

In order to comply with the FDA's requirements for such systems, system 20 is validated by means well known in the art (such as software systems) to ensure its accuracy and reliability, and to ensure that system 20 has the ability to discern if the electronic records it creates, modifies, maintains, and transmits, are invalid or altered. In addition to generating accurate and complete copies of the electronic records, system 20 also has the ability to generate accurate and complete copies of information about ingredients in human readable form, both of which are suitable for inspection, review, and copying by the FDA. The ability to make hard copies is accomplished by means known in the art, such as software, and, more specifically printing capability from the database holding the records.

These records are protected, such as by security software and/or hardware, so that they can be readily and accurately retrieved during the applicable records retention period of the FDA. Access to system 20 is limited to authorized individuals through the use of passcodes, as described above. Additional security measures well known in the art can be used to enhance security. Further, those individuals who develop, maintain, or use system 20 must have the education, training, and experience to perform their assigned tasks. In addition, authority checks, such as the passcodes described above, are utilized to ensure that only authorized individuals can use system 20, electronically sign a record, access system 20 to create, modify, or transmit an electronic record, or otherwise perform functions related to system 20.

System 20 utilizes secure, computer-generated, time stamped audit trails by means well-known in the art to independently record the date and time that authorized users of system 20 create, modify, or delete electronic records. Any modifications to the information about the ingredient will not obscure any previously recorded information. The audit-trail documentation is maintained for at least as long as the applicable records retention period of the FDA for electronic records, and shall be available to the FDA for review and copying.

In addition, operational system checks are utilized to enforce permitted sequencing of steps and events. For example, before system 20 allows an electronic record to be distributed to the FDA, the user must enter all information required by the FDA. As appropriate, checks are also utilized to determine the validity of the source of the information associated with ingredients which is entered into system 20, as well as the source of other operational instructions. Further, users of system 20 must adhere to the written policies which hold such users accountable and responsible for any actions initiated under their electronic signature. In one embodiment of the present invention, these written policies are posted on the specific URL on the Internet for system 20. In order to further comply with the FDA's requirements for electronic record/electronic signature systems, the documentation for system 20 is adequately controlled by controlling the distribution of, access to, and use of the documentation for the operation and maintenance of system 20, as well as by documenting the time-sequenced development and modification to the documentation for system 20 via an audit trail.

System 20 is an open system for the purposes of 21 C.F.R. Part 11. As defined therein, access to system 20 is not controlled by those individuals responsible for the content of the electronic records created, modified, maintained or transferred via system 20. Therefore, in order to comply with the FDA's requirements, additional measures may be required to ensure the authenticity, integrity, and confidentiality of the electronic records.

Software and hardware are available to ensure the authenticity, integrity, and, when appropriate, the confidentiality of the electronic records created, modified, maintained, or transmitted via system 20, and to ensure that an individual cannot repudiate the signed electronic record as not being genuine, all as required by the FDA in 21 C.F.R. Part 11. Further, consulting services are also available to ensure compliance with 21 C.F.R. Part 11. The consulting services include, but are not limited to information about the software and hardware available for aiding in compliance with 21 C.F.R. Part 11, as well as system assessment. For example, OpenText Corporation's software product LiveLink ensures compliance with 21 C.F.R. Part 11. Other companies such as Clarkston, Inc. of North Carolina, NuGenesis Technologies, and Flexware Integration provide software, hardware, and/or consulting services related to 21 C.F.R. Part 11 compliance.

The transfer of the electronic certificate or record associated with the characteristics, certifications, and registrations, or other information about the ingredient purchased to the buyer, or to the organizations regulating the ingredient industry saves the parties to the exchange both time and money because the documentation does not have to be assembled and shipped manually. The buyer can also request the transfer of the seller's electronic signature necessary for the completion of the transaction between the buyer and seller, as well as for the purposes of complying with regulatory agencies and organizations.

In one embodiment of the present invention, the buyer may also request the transfer of any information relating to the ingredient the buyer desires to purchase prior to submitting his or her ingredient inquiry to host server 22. For example, the buyer may wish to view the certifications available for lactic acid prior to investing time in completing the ingredient inquiry if the necessary certifications are not available.

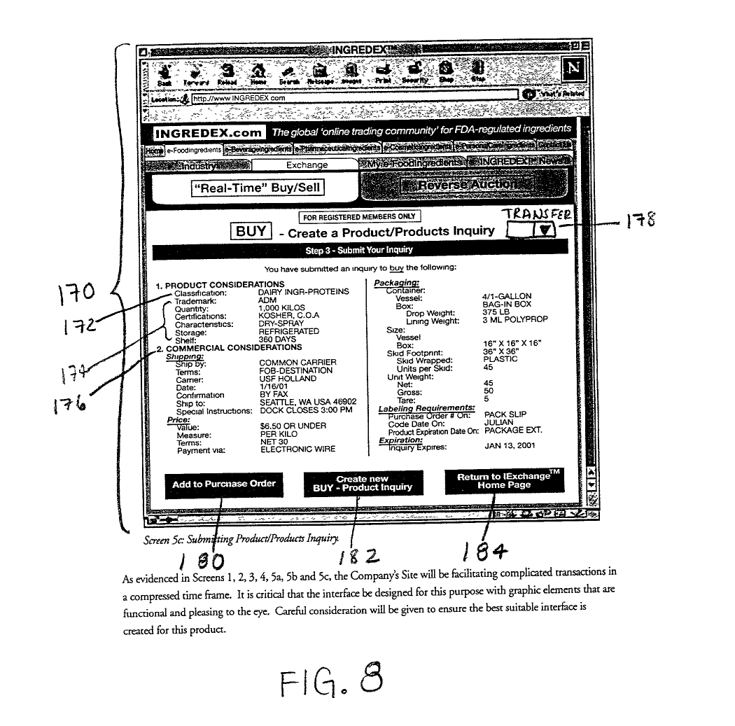

In one embodiment of the present invention, after the buyer enters the information about the ingredient he or she wishes to purchase, the ingredient inquiry is displayed in the form of a buyer's summary page and is shown on remote device 30. An exemplary buyer's summary page 170 is shown in FIG. 8. The summary page 170 includes the name identifier of the ingredient 172, the additional information about the ingredient 174, and the commercial considerations 176 associated with the ingredient entered by the buyer. At option 178, the buyer may request the transfer from the seller to buyer of any information relating to the ingredient that the buyer desires to purchase from the seller. The buyer may also request the electronic signature of the seller. At option 180, the buyer can choose to transfer the information entered by the buyer to host server 22 which stores the information in database 26. At option 182, the buyer can create another product inquiry at steps 38, 40, 42, and 44 or delete all or part of the information contained in the ingredient inquiry in order to correct mistakes in the information at step 51. At option 184, the seller may also return to introductory page 67 as shown in FIG. 3 and discussed above.

After the information entered by the buyer is communicated to host server 22, the buyer is provided with the choice of returning to step 36 or exiting the system. If the buyer returns to step 36, the buyer must indicate whether he or she will be a buyer or seller for the next ingredient in which he or she desires to transact, or if he or she will be entering and/or transferring information about an ingredient. If the buyer exits the system, the buyer will return to step 34 and must re-enter his or her valid passcode.

Returning to step 36, if the user specifies that he or she desires to enter and/or transfer information about an ingredient, at step 40 the user enters the name identifier associated with the ingredient. For example, if the user desires to information about lactic acid, the user may enter the name identifier “lactic acid” at step 40. After the user enters the name identifier of the ingredient, at step 44 the user may enter additional information about an ingredient similar to the additional information about an ingredient a buyer or seller may enter. The additional information a user may enter includes, but is not limited to trademarks associated with the ingredient; certifications associated with the ingredient including, but not limited to regulatory and microbial certifications; characteristics of the ingredient; the type of storage for the ingredient; the shelf life of the ingredient; and registrations associated with the ingredients. At step 44, the user may also enter other commercial considerations associated with the ingredient similar those discussed above that buyers and sellers of ingredients may enter at step 44. Thereafter, the user may communicate the data to host server 22 in steps 50 and 51, and specify the mode of transfer of any information about the ingredient that will be transferred to the user at step 52.

For example, the user may have sold the ingredient to a buyer via another on-line ingredient exchange, but desires to transfer the relevant information about the ingredient, such as the certifications, registrations, and characteristics associated with the ingredient, using the present invention. In another example, the user may enter information about an ingredient in order to use the present invention to transfer information to the organizations regulating the ingredient industry in order to comply with their respective requirements.

At step 54, the user may request the transfer from the party to whom he or she is transferring information about the ingredient of any information relating to the ingredient. For instance, the user may wish to request confirmation from the regulatory agencies that they have received the information transferred via to them. After the user enters the request for transfer at step 54, the user then enters the mode of transfer at step 56, as described above.

Returning to step 36, if a user does not wish to enter information about an ingredient, but simply desires to transfer information about an ingredient that has already been entered into system, the user goes from step 36 directly to step 50. At step 50, the user can specify to whom the information should be transferred. For example, the user may request that the information be transferred back to the user for the user's own personal records. The user may also request that this information be transferred to a buyer or seller of ingredients even though system 20 was not the vehicle for the exchange of the ingredient about which the user entered information. Lastly, the user may specify that the information be transferred to the applicable regulatory agencies. The information about the ingredient may have already been entered manually, as described above. In one embodiment of the present invention, the information may automatically be entered and retrievably stored in database 26 through an interface between other systems including, but not limited to other on-line ingredient exchanges, and host server 22. After the user enters the request for transfer at step 50, the user enters the mode of transfer at step 52, as described above. Thereafter, at step 54, the user may request the transfer of information relating to the ingredient from the party to whom he or she is transferring information about the ingredient, and at step 56 may request the mode of this transfer, as described above.

In one embodiment of the present invention, if the user requests the electronic transfer of the information stored retrievably in database 26, host server 22 retrieves the information from database 26 and generates an electronic record representing the information entered about the ingredient, as described above. This electronic record may be authenticated with an electronic signature. As these electronic records (which may be linked with an electronic signature) may be utilized to fulfill the requirements of the regulatory agencies for maintaining records and submitting records to such agencies, system 20 and the electronic records and signatures created therewith meet the applicable requirements including, but not limited those applicable to the FDA in 21 C.F.R. Part 11.

In another embodiment of the present invention, it is possible to trace an ingredient back to its original source for product liability and quality control purposes, as well as for compliance with the applicable requirements of the agencies regulating the ingredient industry. For example, if a pizza producer purchased various ingredients to make pizzas, the buyer may need information about the ingredients in the pizzas it purchased from various sellers if consumers of the pizzas become sick after the consuming the pizzas. It may be determined that the cheese the buyer purchased from Seller A is causing individuals to become sick. However, it may further be determined that an ingredient in the cheese, such as the food flavoring added to the cheese, which flavoring Seller A bought from Seller B, is the reason for the food poisoning. As system 20 allows any data entered to be retrievably stored, as well as archived, it is possible for the pizza producer to trace the offending ingredient to the beginning of the supply chain. Further, it would be possible to prove that Seller B represented that the food flavoring had certain certifications associated therewith, and authenticated such representation with an electronic signature. For example, in one embodiment of the present invention, the documentation representing various information about the cheese, including its characteristics, registrations, and certifications, contains a code identifying the name identifier and source of any subingredient contained in the cheese. The documentation may consist of an electronic record. This code can then be used to retrieve the documentation for each of the subingredients, such as the food flavoring, contained in the cheese by means well known in the art.

It will be appreciated by those of skill in the art that the system of the present invention is useful for the exchange of raw materials among a plurality of buyers and sellers. A particular user may both buy and sell raw materials using the system. The modes of exchange of raw materials include those well known in the art, including but not limited to buy/sell, auction, reverse auctioning, exchange in like-kind, or otherwise.

The system and method allows exchange of a raw material which may be used by a variety of industries for a variety of purposes, yet help to insure that the raw material exchanged is the specific material required by the buyer. Use of the present invention should therefore significantly lessen the possibility for errors in the exchange of raw materials, for the raw material can be identified and specified with sufficient particularity.

It will also be appreciated by those of skill in the art that the present invention is not limited to use in connection with “ingredients”. The system and method presented herein has direct benefit to a variety of raw materials which are of the general type to be used for multiple industries and/or applications.

The present invention provides a system and method for exchange of raw materials across industries. It also permits buyers and seller to exchange based on criteria besides simply the name identifier of the ingredient including, but not limited to characteristics, certifications, and registrations associated with the raw material. In addition, it permits for the transfer of any information associated with the exchange to buyers and sellers. The present invention is also useful for the maintenance and transfer of information about raw materials, which is often required by the regulatory agencies, regardless of whether ingredients are exchanged via the present invention. Further, the present invention tracks all of the information associated with the raw materials through the entire supply chain of raw materials contained in an end product. The information includes, but is not limited to electronic signatures and records representing characteristics, certifications, and registrations associated with the raw material. The electronic records and electronic signatures are trustworthy, reliable, and are generally equivalent to paper records and handwritten signatures executed on paper. Thus, the system and method has applicability for any raw materials which can be identified by information other than simply the name identifier of the raw material.

I claim:

1. A system for the exchange of at least one raw material, the system comprising:
means for data storage having a database thereon, the database comprising a name identifier and at least one criterion associated with each of the at least one raw material;
means for processing the database, the processing means operably connected to the data storage means;
a first terminal having a means for data entry; and
means for communication between the processing means and the first terminal, the communication means operably connected to the processing means and the first terminal, such that a user may enter by the data entry means of the first terminal a selected name identifier or a selected criterion for communication via the communication means of the entered data to the processing means for subsequent selection from the data storage means by the processing means of one of the at least one raw materials matching the entered data.

2. The system of claim 1, wherein the at least one raw material comprises at least one ingredient.

3. The system of claim 2, wherein the at least one ingredient is of the type used in one or more of the group of industries consisting of the food, beverage, cosmetic, personal care, and pharmaceutical industries.

4. The system of claim 1, wherein the at least one criterion comprises at least one classification.

5. The system of claim 1, wherein the at least one criterion comprises at least one certification.

6. The system of claim 1, wherein the at least one criterion comprises at least one registration.

7. The system of claim 1, wherein the at least one raw material is of the type useful in industries having more than one SIC code associated therewith.

8. The system of claim 1, wherein in the at least one raw material is of the type useful in goods having more than one HTS index associated therewith.

9. The system of claim 1, wherein the first terminal comprises a means for data retention for receipt of database information for the selected at least one raw material.

10. The system of claim 9, wherein the data retention means comprises a storage means.

11. The system of claim 9, wherein the data retention means comprises a display means.

12. The system of claim 9, wherein the data retention means comprises a printing means.

13. The system of claim 1, wherein the f irst t erminal comprises a mea ns for receipt of a user identifier, such user identifier required for receipt of information about the selected at least one raw material.

14. The system of claim 13, wherein the user identifier includes a password.

15. The system of claim 13, wherein the user identifier includes an electronic signature.

16. The system of claim 1, further comprising: a second terminal operably connected to the communication means.

17. The system of claim 16, wherein the at least one name identifier and the at least one criterion of the at least one raw material in the database originate from the second terminal as communicated by the communication means and processed by the processing means to the database.

18. The system of claim 16, wherein the first and second terminals communicate via the communication means.

19. A method of exchange of at least one raw material, the method comprising the steps of:
providing the system of claim 1;
establishing communication via the communication means between the first terminal and the processing means;
entering at the data entry means of the first terminal either a name identifier or an at least one criterion;
with the processing means, selecting one of the at least one raw materials from the database that satisfied the data entered; and
communicating the selected at least one raw material to the first terminal from the processing means via the communication means.

20. The method of claim 19, wherein the at least one raw material is of the type useful in industries having more than one SIC code associated therewith, such that the selected at least one raw material is not depended upon SIC code.

21. The method of claim 19, wherein the system further comprises a second terminal operably connected to the communication means, the method further comprising the step of:
communicating from the second terminal via the communication means to the processing means at least one name identifier and at least one criterion for at least one new raw material; and
adding with the processing means to the database the at least one name identifier and the at least one criterion for the at least one raw material to the database.

22. A system for the exchange of raw materials, comprising:
data storage means;
processing means operably connected to the data storage means;
data representing the at least one raw material, the data representative of at least one criterion associated with the at least one raw material, the data stored in the data storage means;
a first terminal having a data entry means;
an electronic certificate representing the at least one criterion; and
communication means operably connected to the processing means and the first terminal.

23. The system of claim 22, wherein the at least one criterion comprises at least one certification.

24. The system of claim 22, wherein the at least one criterion comprises at least one registration.

25. The system of claim 22, wherein the at least one criterion comprises at least one characteristic.

26. The system of claim 23 wherein the at least one criterion further comprises at least one registration.

27. The system of claim 24, wherein the at least one criterion further comprises at least one characteristic.

28. The system of claim 23, wherein the at least one criterion further comprises at least one characteristic.

29. A method for exchange of at least one raw material, the method comprising the steps of:
providing the system of claim 22;
establishing communication with the communication means between the first terminal and the processing means;
entering a desired criterion with the data entry means of the first terminal;
selecting with the processing means the at least one raw material stored in the data storage means that matches the entered criterion; and
communicating the electronic certificate associated with the selected at least one raw material with the communication means to the first terminal.

30. The method of claim 29, further comprising the step of:
communicating the selected at one raw material to the first terminal.

31. The method of claim 29, wherein the system further comprises a second terminal operably connected to the communication means, the method further comprising the step of:
communicating the electronic certificate associated with the selected at least one raw material with the communication means to the second terminal.

32. A system for the maintenance and transfer of information about at least one raw material, the system comprising:
means for data storage having a database thereon, the database comprising a name identifier and at least one characteristic, registration, or certificate associated with the at least one raw material;
means for processing the database, the processing means operably connected to the data storage means;
a first terminal having a means for data entry;
an electronic record representing the at least one characteristic, registration, or certificate associated with the at least one raw material;
means for communication operably connected to the processing means and the first terminal, such that a user may communicate the electronic record representing the at least one characteristic, registration, or certificate associated with the at least one raw material to a second terminal with the communications means.

33. The system of claim 32, wherein the electronic record comprises an electronic signature.

34. The system of claim 33, wherein the at least one raw material comprises at least one ingredient.

35. The system of claim 34, wherein the at least one ingredient is of the type used in one or more of the group of industries consisting of the food, beverage, cosmetic, personal care, and pharmaceutical industries.

36. The system of claim 32, further comprising a means to validate the system to ensure its accuracy, reliability, and ability to discern the alteration or invalidity of the electronic record representing the at least one characteristic, registration, or certification associated with the at least one raw material.

37. The system of claim 36, wherein the system generates a human readable version of the at least one characteristic, registration, or certification represented by the electronic record that is capable of human inspection, review, and copying.

38. The system of claim 37, wherein the system further comprises a means for protecting the electronic record representing the at least one characteristic, registration, or certification associated with the at least one raw material for a defined period of time so that the electronic record representing the at least one characteristic, registration, or certification associated with the at least one raw material can be retrieved from the data storage means using the processing means.

39. The system of claim 32, further comprising a means for tracking the electronic record representing the at least one characteristic, registration, or certificate associated with the at least one raw material for every raw material contained in an end product.

40. A method for maintaining and transferring information about at least one raw material, the method comprising the steps of:
providing the system of claim 33;
establishing communication with the communication means between the first terminal and the processing means;
selecting the at least one raw material;
communicating the electronic record representing the at least one characteristic, registration, or certificate associated with the at least one raw material to the second terminal using the communications means.
